(19) United States
(12) Patent Application Publication
(10) Pub. No.: US 2008/0213637 A1
(43) Pub. Date: Sep. 4, 2008

(54) Gas Station Hydrogen

(75) Inventor: Meyer Steinberg, Meville, NY (US)

Correspondence Address: LOUIS VENTRE, JR, 2483 OAKTON HILLS DRIVE, OAKTON, VA, 22124-1530, US

(73) Assignee: HCE, LLC, Oakton, VA (US)

(21) Appl. No.: 11/969,952

(22) Filed: Jan. 7, 2008

Related U.S. Application Data
(60) Provisional application No. 60/885,116, filed on Jan. 16, 2007.

(51) Int. Cl. H01M 8/18

(52) U.S. Cl. 429/17; 429/19

(57) ABSTRACT

A device and method of using the device to convert gasoline to hydrogen with zero carbon dioxide emissions and are suitable for co-location at a gasoline filling station. The device has a plasma reactor (100); a container (140); a port to withdraw hydrogen (101) from the plasma reactor; a fuel cell (150); and, a means for storing hydrogen. The method of using the device includes steps for introducing gasoline into the plasma reactor; cracking the gasoline; holding carbon in the container; withdrawing hydrogen from the plasma reactor to supply a first portion to a fuel cell and a second portion that is further divided into a third portion that is recycled back to the plasma reactor and a fourth portion that is sent to the means for storing hydrogen; and, producing electricity to operate the plasma reactor using the first portion of hydrogen as fuel in the fuel cell.

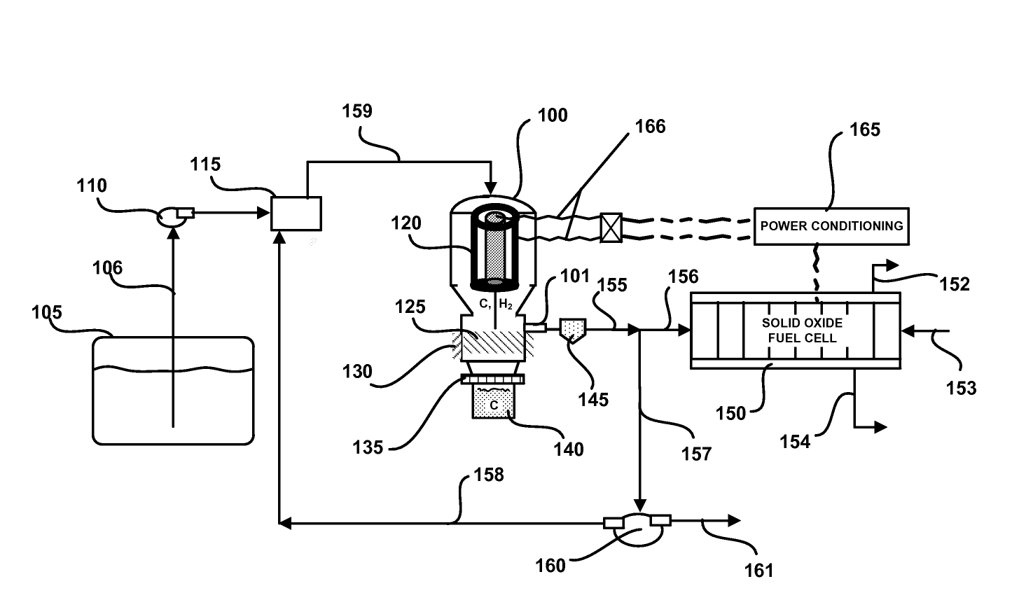

### CROSS-REFERENCE TO RELATED APPLICATIONS

The present invention claims the benefit of the filing date of U.S. Provisional application 60/885,116 filed 16 Jan. 2007, the entire disclosure of which is incorporated by reference herein.

### FIELD OF INVENTION

In the field of hydrogen production, a device and process for converting gasoline and diesel fuels to hydrogen with zero carbon dioxide emissions and suitable for co-location at existing gasoline filling stations.

### DESCRIPTION OF PRIOR ART

Hydrogen is a prospective transportation fuel and in order to be able to use it for such purposes the question of how to generate and deliver the gas to end users must be answered through means that are practical and cost effective and have low or no greenhouse gas emissions.

Current technology for hydrogen production is based on thermocatalytic processes or on catalytic autothermal steam reforming processes. The present invention uses a plasma and does not employ a catalyst to produce hydrogen.

Plasma reactors of the type used in the present invention produce an electric arc or plasma that operates to crack the fuel without the use of materials or gases that pollute the decomposition products or catalyze the decomposition process. U.S. Pat. No. 5,997,837 teaches use of this type of reactor using natural gas feed to product carbon black.

Typical of the technologies involving thermocatalytic process is U.S. Pat. No. 6,653,005, which is for portable self-contained power apparatus utilizing a hydrogen generator that employs a catalyst coupled to or integrated with a fuel cell. The present invention is a significant improvement because the use of a plasma reactor eliminates the catalyst, lowers cost, improves efficiency and enables the sale of hydrogen in excess of that needed to produce electricity to power the process without carbon dioxide production.

Typical of the technologies involving steam reforming is U.S. Pat. No. 7,132,178 involving a hydrogen generator, fuel cell system and control method of hydrogen generation. To enable steam reforming, a water supply is needed along with a reforming catalyst and a carbon monoxide removing unit reducing the content of carbon monoxide in hydrogen gas produced in the reformer.

Steam reforming processes are costly, require fuel sources different from liquid transportation fuels, require a large real estate footprint, require attention to fuel supply logistics for co-locating at gasoline filling stations, require a catalyst and regular replacement of the catalyst and produce significant carbon dioxide emissions.

Hydrogen generation with the steam reforming process has been proposed for central plants, which would deliver hydrogen to concessions, mainly vehicle refueling stations, by pipeline or truck. There is also significant activity in building skid-mounted, natural-gas fueled hydrogen production plants, which also use steam reforming and are potentially sited at refueling stations. A natural gas supply would be required to fuel these skid-mounted plants The present invention presents another option, that of generating hydrogen at existing gasoline refueling stations using existing liquid fuels, gasoline and diesel, as feedstock in a process that does not involve steam reforming, has a smaller footprint, is cost effective and does not produce carbon dioxide.

High temperature fluid wall reactors have also been proposed for chemical decomposition of hydrocarbons. Representative of this art is U.S. Pat. No. 4,056,602. The present invention uses a much simpler plasma reactor with no fluid walls and does not depend on the reactants absorbing radiant energy.

The present gasoline to hydrogen production process is also called the Plasma Hydrogen Process. The plant for implementing the process consists of a plasma reactor operating on gasoline to produce gaseous hydrogen and solid carbon. The term gasoline is used herein to include typical liquid transportation fuels such as gasoline and diesel fuels and the blends of gasoline commonly sold as transportation fuels.

The preferred embodiment of the invention is sized to be co-located with gasoline filling stations and is a self-contained plant with gasoline added as the fuel. In steady state operations, the plant produces electric power from a fuel cell for use in the plasma reactor. The fuel cell uses a portion of the hydrogen produced in the process to generate electricity used by the plasma reactor. Carbon is separated from the gasoline and collected in the plasma reactor without the need or use of a catalyst. No carbon dioxide is produced in cracking the fuel, only solid carbon and gaseous hydrogen. The carbon is collected from the plasma reactor, then disposed of, or sold as a commodity for various applications. The hydrogen in excess of that used by the fuel cell is marketed and dispensed at the gasoline station.

Accordingly, the present invention will serve to improve the prior art of hydrogen production based on steam reforming of liquid transportation fuel in a number of ways:

The steam reforming process requires three reactors: (i) steam-liquid fuel reforming reactor; (ii) water gas shift reactor; and (iii) separation of pure hydrogen from carbon dioxide and nitrogen or separation of carbon dioxide from diluted hydrogen with nitrogen. The Plasma Hydrogen Process requires a plasma reactor and a fuel cell.

Autothermal steam reforming requires a catalyst and its periodic replacement while the Plasma Hydrogen Process is purely thermal and does not require a catalyst.

Steam reforming requires steam and oxygen feed in addition to the fuel. The Plasma Hydrogen Process only requires the liquid feed. To make the process self-contained and to eliminate carbon dioxide production, the electrical power is provided by a solid oxide fuel cell.

For gasoline filling stations selling 3,000 gallons of gasoline per day, steam reforming of an energy equivalent amount of hydrogen would generate 31.2 tons of carbon dioxide, which would be emitted to the atmosphere as a greenhouse gas. In contrast, the Plasma Hydrogen Process does not generate any carbon dioxide to the atmosphere, but similar consumption of gasoline produces 8.5 tons of solid carbon per day, which may have market value for example as a building material, or can be sequestered in mines or landfill.

Steam reforming produces an impure hydrogen mixed with nitrogen and carbon dioxide and requires that the hydrogen be cleanly separated from the other gases in an additional step. The Plasma Hydrogen Process directly produces a pure hydrogen stream, thus requiring no further gas separation.

### BRIEF SUMMARY OF THE INVENTION

A device and method of using the device convert liquid transportation fuel to hydrogen with zero carbon dioxide emissions and are suitable for co-location at a gasoline filling station. The device has a plasma reactor capable of cracking a liquid transportation fuel into hydrogen and carbon; a container for holding the carbon; a means to withdraw the hydrogen from the plasma reactor; a fuel cell to consume a first portion of the hydrogen and produce electricity to run the plasma reactor; and, a means for storing hydrogen. The method of using the device includes steps for introducing liquid transportation fuel into the plasma reactor; cracking the liquid transportation fuel in the plasma reactor into hydrogen and carbon; holding the carbon in the container; withdrawing the hydrogen from the plasma reactor to supply a first portion to a fuel cell and a second portion wherein the second portion of hydrogen is further divided into a third portion that is recycled back to the plasma reactor and a fourth portion that is sent to the means for storing hydrogen; and, producing electricity in the fuel cell using the first portion of hydrogen as fuel, wherein the electricity is used to operate the plasma reactor.

### BRIEF DESCRIPTION OF THE DRAWINGS

The drawing is a schematic of the preferred apparatus of the invention to produce hydrogen using a solid oxide fuel cell to generate electricity to power the plasma reactor in the process.

### DETAILED DESCRIPTION

In the following description, reference is made to the accompanying drawing, which forms a part hereof and which illustrates a preferred embodiment of the present invention. The drawing and a preferred embodiment of the invention are presented with the understanding that the present invention is susceptible of embodiments in many different forms and, therefore, other embodiments may be utilized and structural and operational changes may be made without departing from the scope of the present invention.

A preferred embodiment of the invention converts liquid transportation fuel, preferably gasoline or diesel fuel, to hydrogen with zero carbon dioxide emissions and is suitable for co-location at a gasoline filling station. It includes a plasma reactor capable of cracking a liquid transportation fuel into hydrogen and carbon; a container for holding the carbon; a means to withdraw the hydrogen from the plasma reactor; a fuel cell to consume a first portion of the hydrogen and produce electricity to run the plasma reactor; and, a means for storing hydrogen.

The first element is a plasma reactor (100) capable of cracking a liquid transportation fuel into hydrogen and carbon are well known in the prior art. The preferred plasma reactor employs a hydrogen environment in which the liquid transportation fuel cracking process is conducted. A hydrogen environment assures that only hydrogen is extracted from the reactor and not hydrogen in combination with air or other gases. The hydrogen environment also reduces energy requirements for the plasma. While any type of electrode may be used, the preferred plasma reactor also utilizes graphite electrodes (120) to create a plasma to crack the fuel.

The plasma reactor optionally uses an aspirator (115) to atomize the fuel (106) with recycled hydrogen (156). The atomized fuel and hydrogen (159) is fed into the plasma reactor (100) for cracking. A fuel pump (110), for example the pre-existing gasoline filling station fuel pump, is optionally used to pump the fuel (106) from its underground tank (105) at the gasoline filling station into the aspirator. Other arrangements involving a gasoline storage tank different from the gasoline filling station storage tank, and gravity feed to the plasma reactor are within the scope of the invention.

The second element is a container (140) for holding the carbon. While location of the container is largely irrelevant to the invention, the container is preferably located below the plasma cracking section of the plasma reactor so that gravity will act upon the solid carbon and deliver it to the container.

The container (140) is optionally connected to the plasma reactor by a quick disconnect coupling (135) that aids in periodic removal of the solid carbon. Other arrangements involving suctioning or blowing the carbon to a large storage container are within the scope of the invention.

The plasma reactor optionally has a baffled cooling chamber (125) to cool the carbon prior to its entry to the container. Cooling is enhanced by cooling fins (130) on the exterior of the baffled cooling chamber.

The third element is a means to withdraw the hydrogen from the plasma reactor. This is as simple as a port (101) which allows the hydrogen gas (155) to flow out of the reactor. The flow may be aided by a pump (160). A filter (145) optionally removes entrained carbon from the hydrogen. The pump (160) further provides a means to divide the second portion of hydrogen (158) into a third portion (156) that is recycled back to the plasma reactor (100) and a fourth portion (159) that is sent to a means for storing hydrogen.

The fourth element is a fuel cell (150) to consume a first portion of hydrogen (156) and produce electricity (166) to run the plasma reactor. The fuel cell enables operation independently of the electrical power grid and because it produces no carbon dioxide in the production of electricity, this embodiment operates without adding to greenhouse gas emissions. If required, a power conditioning unit (165) would change the voltage or current of the electricity produced by the fuel cell (150) to match the requirements of the plasma reactor (100). The fuel cell (150) takes the first portion of hydrogen (157) electrochemically combines the hydrogen with oxygen from air (153) to produce electricity, emits oxygen depleted air (152), and emits liquid water (154).

The fifth element is a means for storing hydrogen in any hydrogen storage mechanism. The specific means used is not important to the invention, only that a portion of hydrogen (161) be captured and not lost after it is created in the fuel cracking process. For example, the means for storing may be a tank for storing compressed hydrogen. The means for storing may simply be the vehicle into which the hydrogen is dispensed when purchased at the gasoline filling station. This scope of the invention includes any means for storing hydrogen.

The preferred process of the invention is a method for using the device described above as the preferred embodiment of the invention. The process includes steps for introducing liquid transportation fuel into the plasma reactor (100); cracking the liquid transportation fuel in the plasma reactor into hydrogen and carbon; holding the carbon in the container (140); withdrawing the hydrogen (155) from the plasma reactor to supply a first portion of hydrogen (156) to a fuel cell (150) and a second portion of hydrogen (157) wherein said second portion of hydrogen (157) is further divided into a third portion third portion of hydrogen (158) that is recycled back to the plasma reactor and a fourth portion of hydrogen (161) that is sent to the means for storing hydrogen; and, producing electricity in the fuel cell using the first portion of hydrogen as fuel, wherein the electricity (166) is used to operate the plasma reactor.

The first process step of introducing liquid transportation fuel into the plasma reactor may be accomplished by any means such as with the use of an aspirator (115), as noted above.

The second process step of cracking the liquid transportation fuel in the plasma reactor into hydrogen and carbon is accomplished simply by operating the plasma reactor.

The third step of holding the carbon in the container is preferably performed by gravity assisted settling of the solid carbon that is created when the fuel is cracked.

The fourth step of is withdrawing the hydrogen from the plasma reactor to supply a first portion to a fuel cell and a second portion wherein said second portion of hydrogen is further divided into a third portion of hydrogen (158) that is recycled back to the plasma reactor and a fourth portion of hydrogen (161) that is sent to the means for storing hydrogen. This step is preferably performed with the assistance of a pump (160). In this embodiment, hydrogen is continuously circulated through the plasma reactor. The hydrogen (155) that is first withdrawn from the plasma reactor is separated to send a first portion of hydrogen (156) to the fuel cell, a second portion of hydrogen (157) to be again divided into a third portion of hydrogen (158) that is returned to the plasma reactor (100) via the aspirator (115), and a fourth portion of hydrogen (161) that is the product of the process.

The fifth step is producing electricity in the fuel cell using the first portion of hydrogen (156) as fuel, wherein the electricity (166) is used to operate the plasma reactor. Operation of a fuel cell is well known in the art.

### EXAMPLE

An average refueling station sells about 3,000 gallons of gasoline per day. Gasoline, represented by the chemical formula CH₂, can be separated into its component parts with the addition of energy. The separation is represented by the equation: CH₂═C+H₂, where C is the chemical symbol for carbon and H₂ is the chemical symbol for a molecule of hydrogen gas. The additional energy required is equal to +6,000 calories/gram-mole of gasoline and is obtained in the preferred embodiment of the invention from the thermal equivalent of electrical power supplied by the plasma.

Assuming a conservative 36% process efficiency for plasma decomposition, the electrical energy requirement for the plasma decomposition of gasoline, CH₂, is given by the calculation 6,000/0.36=16,700 calories per gram-mole.

The mass flow of gasoline=3,000 gallon/day×6.6 pounds/gallon=19,800 pounds/day.

The cracking energy=(16,700×1.8 British Thermal Units)/(14 pounds per pound-mole)=2,150 British Thermal Units per pound.

The electrical power required equals (19,800 pounds×2,150 British Thermal Units/pound) per (24 hours per day×3,413 British Thermal Units per kilowatt-hour)=520 kilowatts.

The tons of carbon per day collected equals ( 12/14)×(19,800 pounds per day/2000 pounds per ton)=8.5 tons per day.

At 50% void volume, the volume of carbon equals (8.5 tons per day×2000 pounds per ton)/(1.8×62.4 pounds per cubic foot)=303 cubic feet of carbon.

Number of 55 gallon drums equals (303 cubic foot×7.485 gallon/cubic foot)/55 gallons/drum=42 drums of carbon per day, weighing 400 pounds per drum.

The amount of hydrogen produced per day equals ( 2/12)×8.5 tons per day=1.42 tons/day=2,830 pounds of hydrogen per day.

By contrast, carbon dioxide emissions from steam reforming would be (44/12)×8.5=31.2 tons carbon dioxide per day, which would be emitted to the atmosphere and which would contribute to greenhouse problems.

In the preferred embodiment, electric power for the plasma reactor is supplied by a fuel cell. Thus, some of the hydrogen is consumed to generate power.

The preferred production per day of hydrogen in gallons of gasoline equivalent is given by the calculation (2,830 pounds per day×60,000 British Thermal Units per pound hydrogen)/120,000 British Thermal Units per gallon of gasoline=1,415 gallons of gasoline equivalent per day.

The conversion efficiency of the process is given by the calculation 1,415/3,000×100=47.2%.

Cost Estimate for Gasoline Station Unit Powered by Electricity Generated On-Site With Solid Oxide Fuel Cell (Solid Oxide Fuel Cell) Using Part of the hydrogen Produced by the Plasma Reactor.

The hydrogen required to generate 520 kilowatt in solid oxide fuel cell is calculated as follows (assuming 55% cell efficiency): 520 kilowatt-hour×(3,413/0.55 efficiency)=3,240,000 British Thermal Units per hour.

The pounds per day of hydrogen fuel required by the solid oxide fuel cell is given by the calculation (3,240,000 British Thermal Units per hour×24 hours per day)/60,000 British Thermal Units per pound hydrogen=1,296 pounds hydrogen per day.

The net output of hydrogen is given by the calculation of the total hydrogen generated minus that consumed by the Solid Oxide Fuel Cell: 2,830−1,296=1,534 pounds hydrogen per day.

The hydrogen in terms of gallons of gasoline equivalent is given by the calculation: 0.5×1,534=767 gallons of gasoline equivalent.

Hydrogen powered fuel cell vehicles deliver 60 miles per gallon versus 20 miles per gallon for gasoline internal combustion engines (ICE). Therefore, the mileage with hydrogen fuel cell cars is given by the calculation: 60 miles per gallon×767 gallons=46,000 miles.

Similarly, the mileage with gasoline internal combustion engines is given by the calculation 20 miles per gallon×3000=60,000 miles.

For obtaining equivalent mileage with hydrogen in a fuel cell car as with gasoline in an internal combustion engine, the plasma must have an efficiency of 60%, instead of 36% as assumed above, so that the energy to crack the gasoline should not be more than: (6,000 calories/gram-mole)/0.6=10,000 calories/gram-mole.

If 60% efficiency is realized, then a plasma reactor of only 310 kilowatts is necessary to decompose 3,000 gallons of liquid hydrocarbon fuel per day and the net hydrogen production is 1,030 gallons of gasoline equivalent.

The capital cost of the plasma reactor is estimated above at $1 million. The capital cost for a fuel cell to power the plasma reactor when mass produced can be as low as $1,000/kilowatt, so that the Solid Oxide Fuel Cell cost is given by the calculation 1,000×520=$520,000. The only item of cost is the fixed charge on the capital cost for the plasma reactor and the solid oxide fuel cell. The total capital cost is therefore: $1,000,000+$520,000=$1,520,000.

Production Cost Calculation (excluding cost of gasoline):

| Item | $/day |
|---|---|
| Fixed Cost of Capital at 20%/year and 7,000 | $1,042.30 |
| hours/year equals | |
| [(0.2 × $1.52 × 10⁶)/7,000]× 24 | |
| Operations and Maintenance at 15% of Fixed Cost | $156.30 |
| equals | |
| 0.15 × 1042.30 | |
| Total | $1,198.60 |
| Unit hydrogen cost in dollars per gallon of gasoline | $1.56 per gallon of |
| equivalent equals $1,198.60/767 | gasoline equivalent |
| | hydrogen |

The disclosure herein is to be considered as an exemplification of the principles of the invention and is not intended to limit the broad aspect of the invention to the embodiments illustrated. Thus, the scope of the invention is determined by the appended claims and their legal equivalents rather than by the examples given.

What is claimed is:

1. A device for converting liquid transportation fuel to hydrogen with zero carbon dioxide emissions and suitable for co-location at a gasoline filling station comprising,
(a) a plasma reactor capable of cracking a liquid transportation fuel into hydrogen and carbon;
(b) a container for holding the carbon;
(c) a means to withdraw the hydrogen from the plasma reactor;
(d) a fuel cell to consume a first portion of the hydrogen and produce electricity to run the plasma reactor; and,
(e) a means for storing hydrogen.

2. The device of claim 1 further comprising a quick disconnect coupling to easily detach the container to remove the carbon.

3. The device of claim 1 wherein the plasma reactor cracks the fuel in a hydrogen environment.

4. The device of claim 1 further comprising a hydrogen pump to aid in hydrogen flow from the plasma reactor and to split the hydrogen.

5. The device of claim 1 further comprising a filter to remove entrained carbon from the hydrogen withdrawn from the plasma reactor.

6. The device of claim 1 further comprising a baffled cooling chamber to cool the carbon prior to its entry to the container, said chamber having cooling fins on its exterior.

7. The device of claim 1 further comprising a power conditioning unit to change voltage or current of the electricity produced by the fuel cell to match requirements of the plasma reactor.

8. The device of claim 1 further comprising an aspirator to atomize the liquid transportation fuel prior to cracking in the plasma reactor.

9. A method for using the device of claim 1 comprising the steps of
(a) introducing liquid transportation fuel into the plasma reactor;
(b) cracking the liquid transportation fuel in the plasma reactor into hydrogen and carbon;
(c) holding the carbon in the container;
(d) withdrawing the hydrogen from the plasma reactor to supply a first portion to a fuel cell and a second portion wherein said second portion of hydrogen is further divided into a third portion that is recycled back to the plasma reactor and a fourth portion that is sent to the means for storing hydrogen; and,
(e) producing electricity in the fuel cell using the first portion of hydrogen as fuel, wherein the electricity is used to operate the plasma reactor.
